(19) United States
(12) Patent Application Publication
(10) Pub. No.: US 2013/0069391 A1
(43) Pub. Date: Mar. 21, 2013

(54) ACCESS TO TRUCK SLEEPER FOR TRIM OPERATIONS

(71) Applicants: Gregory S. Hall, Bothell, WA (US); Jon Polzin, Kenmore, WA (US); Keith French, Kirkland, WA (US); Steven J. Schuh, Renton, WA (US); Tim Brooks, Kirkland, WA (US)

(72) Inventors: Gregory S. Hall, Bothell, WA (US); Jon Polzin, Kenmore, WA (US); Keith French, Kirkland, WA (US); Steven J. Schuh, Renton, WA (US); Tim Brooks, Kirkland, WA (US)

(73) Assignee: PACCAR INC, Bellevue, WA (US)

(21) Appl. No.: 13/237,666

(22) Filed: Sep. 20, 2011

(51) Int. Cl. B62D 47/00; B23P 11/00

(52) U.S. Cl. 296/190.11; 29/428

(57) ABSTRACT

Assemblies for selectively providing access to an interior portion of a vehicle having a sidewall are provided. Methods of manufacturing a vehicle that incorporates the assemblies are also provided. The assemblies utilize an access opening formed in a portion of a sidewall of the vehicle to facilitate trimming the interior of the vehicle. Upon completion of trimming the interior of the vehicle, the access opening is closed out (i.e., covered) with an assembly that may be a door, a fixed panel, or combinations thereof.

### BACKGROUND

To assemble or trim the interior of a truck sleeper, components typically need to be passed through an opening in the sleeper or cab, and the opening is later closed off during the assembly process. The opening must be sufficiently large such that sleeper components, such as a mattress, cabinets, kitchenette accessories, etc., may fit through the opening. For ease of installation, large sections of the sleeper are often removed or otherwise designed for later installation to create a sufficiently large opening in the sleeper during trim assembly. For instance, a large opening may be defined by a removable roof, rear panel, or fire wall.

Although such large openings enable an operator to easily install trim components and allow significant air and light to pass into the sleeper during assembly, such large openings require installation of large closures (i.e., the roof, rear panel, fire wall, etc.) after the interior trim is installed. Large closures often include complicated interfaces that can make installation difficult, leading to incomplete sealing of the closures and an increased risk of damage to the body, interior components, and finished surfaces during installation. The openings defined for the cab doors may also be used, but use of such openings limit the access, light, and air into the sleeper. Moreover, use of the cab door openings for sleeper trim installation prevents simultaneous installation of components within the cab.

What is desired, therefore, is a system that allows for improved access to a truck cab during assembly and trimming in a manner that also improves truck manufacturing efficiency.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a sidewall enclosure assembly for selectively providing access to an interior portion of a vehicle having a sidewall with an access opening formed in the sidewall is provided. In one embodiment, the sidewall enclosure assembly comprises:

(a) an insert selectively attachable to a portion of the sidewall such that it divides the access opening into at least first and second closeout openings; and

(b) at least one modular closeout sealingly engageable with the sidewall and the insert to enclose one of the first and second closeout openings.

In another aspect, a sidewall enclosure assembly is provided. In one embodiment, the sidewall enclosure assembly is configured for selectively providing access to an interior portion of a vehicle having a sidewall and an access opening defined in the sidewall, the access opening sized and configured to allow vehicle interior trim components to be passed through the access opening during vehicle assembly. The sidewall enclosure assembly comprises:

a double door assembly sealingly engageable with the sidewall to cover the access opening, wherein the double door assembly comprises:
(i) an entry door moveable between open and closed positions, the entry door sized and configured to provide access to a first interior portion of the vehicle when the entry door is opened; and
(ii) an access door defined in a portion of the entry door such that access door moves with the entry door when the entry door is moved between open and closed positions, the access door configured to open independent of the entry door and sized and shaped to provide access to a second interior portion of the vehicle.

In another aspect, a method for assembling an interior of a vehicle having a cab portion and a sleeper portion is provided. In one embodiment, the method comprises:

(a) defining an access opening in a sidewall of the sleeper portion of the vehicle that provides access to an interior of the sleeper portion;

(b) passing at least one interior trim component through the access opening and into the interior of the sleeper portion;

(c) installing the at least one interior trim component in the interior of the sleeper portion; and

(d) covering the access opening with a sidewall enclosure assembly, comprising:
(i) an insert selectively attachable to a portion of the sidewall such that it divides the access opening into at least first and second closeout openings; and
(ii) at least one modular closeout sealingly engageable with the sidewall and the insert to enclose one of the first and second closeout openings.

In another aspect, a method for assembling an interior portion of a truck sleeper is provided. In one embodiment, the method comprises:

(a) defining an access opening in a sidewall of the truck sleeper that provides access to the interior portion of the truck sleeper;

(b) passing a sleeper component for installation in the truck sleeper through the access opening and into the interior portion of the truck sleeper;

(c) installing the at least one interior sleeper component in the interior portion of the sleeper; and

(d) covering the access opening with a sidewall enclosure assembly, the sidewall enclosure assembly comprising a double door assembly sealingly engageable with the sidewall to cover the access opening, wherein the double door assembly comprises:
(i) an entry door moveable between open and closed positions, the entry door sized and configured to provide access to a first interior portion of the vehicle when the entry door is opened; and
(ii) an access door defined in a portion of the entry door such that access door moves with the entry door when the entry door is moved between open and closed positions, the access door configured to open independent of the entry door and sized and shaped to provide access to a second interior portion of a vehicle.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a partial-cutaway isometric view of a cab/sleeper unit of a vehicle having an access opening in a sidewall;

FIG. 2 is an isometric view of a first embodiment of a sidewall enclosure assembly for covering the access opening of the cab/sleeper unit of FIG. 1;

FIG. 3 is an isometric view of a second embodiment of a sidewall enclosure assembly for covering the access opening of the cab/sleeper unit of FIG. 1;

FIG. 4 is an isometric view of a third embodiment of a sidewall enclosure assembly for covering the access opening of the cab/sleeper unit of FIG. 1;

FIG. 5 is an isometric view of a fourth embodiment of a sidewall enclosure assembly for covering the access opening of the cab/sleeper unit of FIG. 1;

FIG. 6 is an isometric view of a fifth embodiment of a sidewall enclosure assembly for covering the access opening of the cab/sleeper unit of FIG. 1;

FIG. 7 is an isometric view of a sixth embodiment of a sidewall enclosure assembly for covering the access opening of the cab/sleeper unit of FIG. 1;

FIG. 8 is a cross sectional view of a portion of the sidewall enclosure assembly illustrated in FIG. 6, taken substantially across line 8-8; and

FIG. 9 is a cross sectional view of a portion of the sidewall enclosure assembly illustrated in FIG. 7, taken substantially across line 9-9.

### DETAILED DESCRIPTION

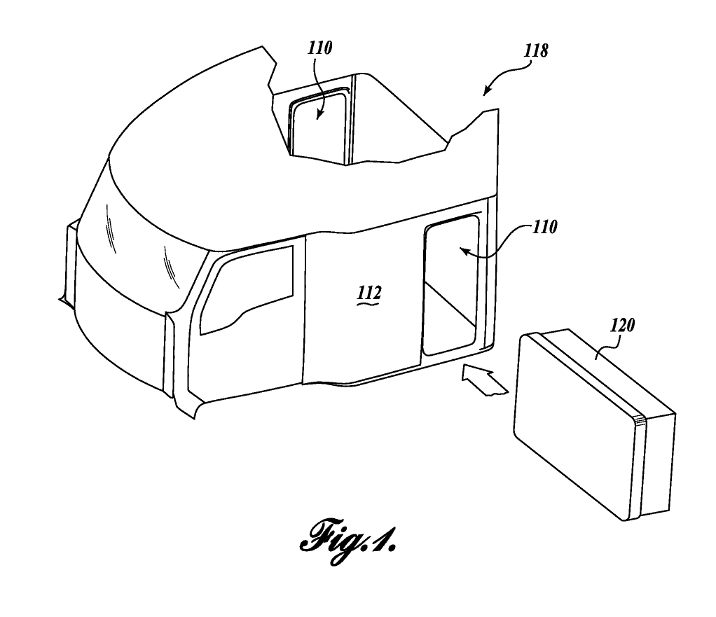

The present disclosure provides various assemblies for selectively providing access to an interior portion of a vehicle. FIG. 1 depicts an untrimmed vehicle shell or body having at least one sidewall 112 with one or more access openings 110 formed therein that provides access to the interior of the vehicle body. In the depicted embodiment, the vehicle body is a portion of a cab/sleeper unit 118 of a heavy-duty truck (e.g., a Class 8 truck). It should be appreciated, however, that the various assemblies described herein are not limited in use to the cab/sleeper unit of a heavy-duty truck, and the descriptions and FIGURES provided herein are for illustrative purposes only and are not intended to limit the scope of the claimed subject matter.

The access opening 110 is located within the sidewall 112 of the vehicle body near the rear of the cab/sleeper unit 118. The access opening 110 is suitable in size and configuration to provide access to the interior of the cab/sleeper unit 118 when uncovered. For instance, the access opening 110 may be generally rectangular in shape and of a sufficient height and width such that, when uncovered, it provides access to both the bed in the sleeper portion of the cab/sleeper unit 118 (when trimmed) and a toolbox or other storage space (not shown for simplicity) located beneath the bed, directly inside the opening 110.

The access opening 110 is also suitable in size and configuration to accommodate the pass-through of various interior trim components of the cab/sleeper unit 118 during assembly. For example, a bed 120 is illustrated in FIG. 1 as an exemplary trim component. As described in the Background section above, sleepers must typically be equipped with relatively large furniture, such as beds, cabinets, and benches. The access opening is suitably sized and shaped to accommodate these or similar components during the cab/sleeper unit assembly process. In other words, the cab/sleeper unit 118 access opening 110 is sized and shaped to allow interior trim components to be passed into the cab/sleeper unit 118 and ultimately used to trim out or finish the interior of the cab/sleeper unit 118. Relatively large items can be loaded through the access opening 110, and the access opening 110 provides sufficient air and light to pass into the interior of the cab/sleeper unit during assembly.

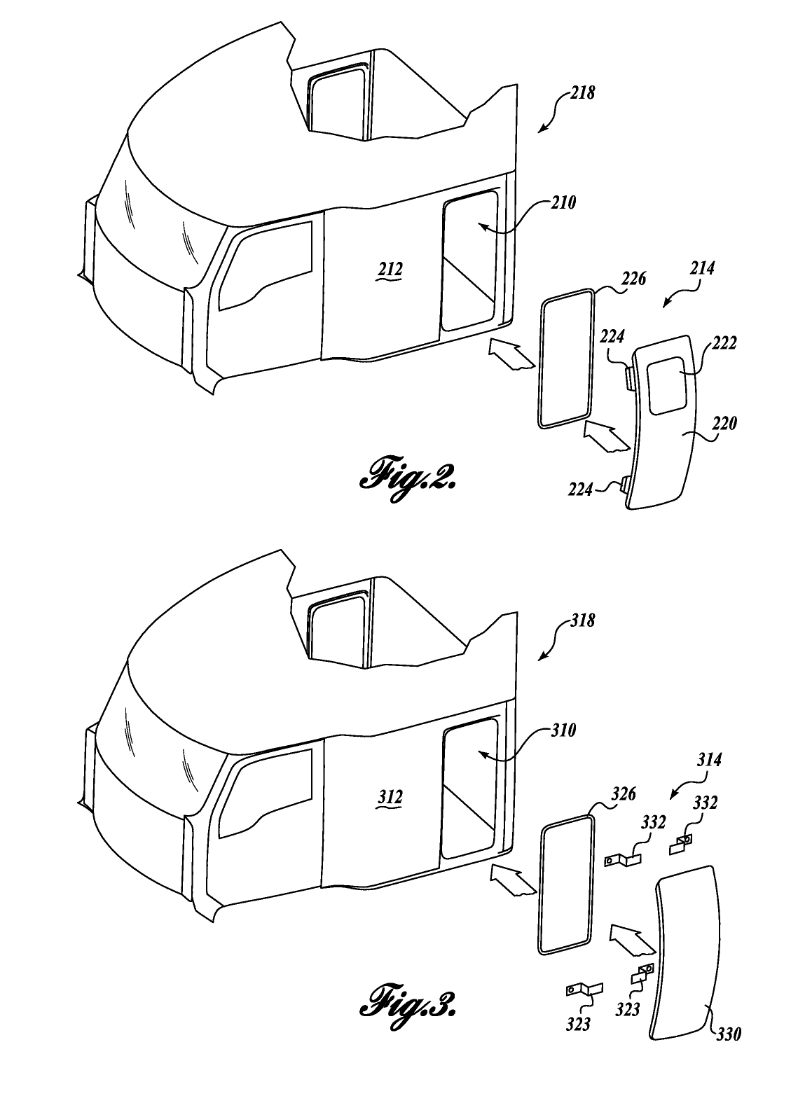

After the trim components have been passed through the access opening 110 and the interior of the cab/sleeper unit 118 has been satisfactorily assembled, the access openings 110 are covered by securing a sidewall enclosure assembly within the access opening 110 of the sidewall 112. FIGS. 2-8 depict various embodiments of sidewall enclosure assemblies configured for use with a vehicle having an access opening 110 or a similar opening.

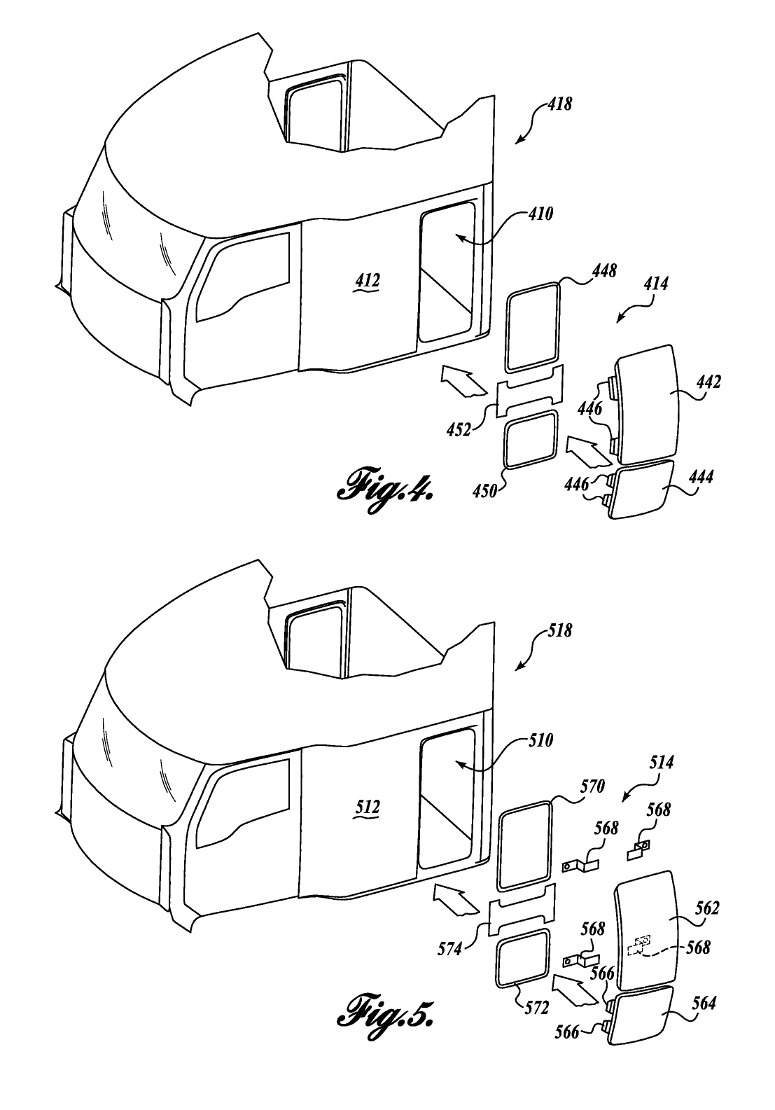

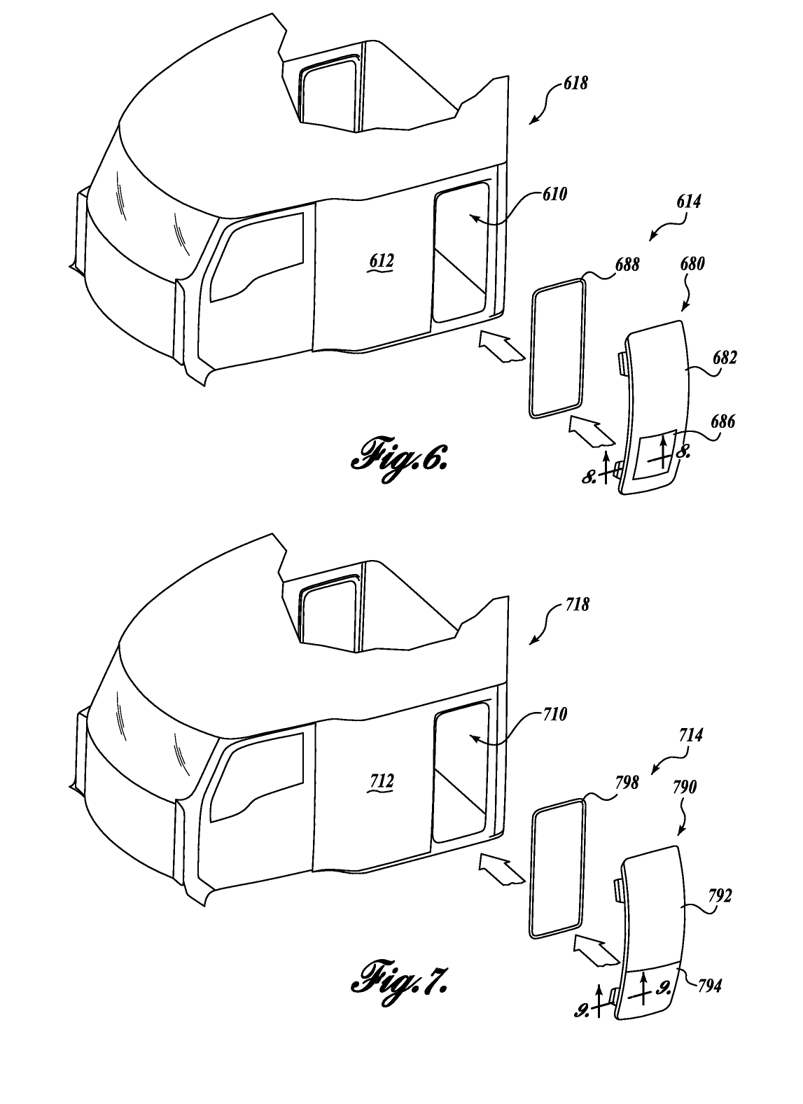

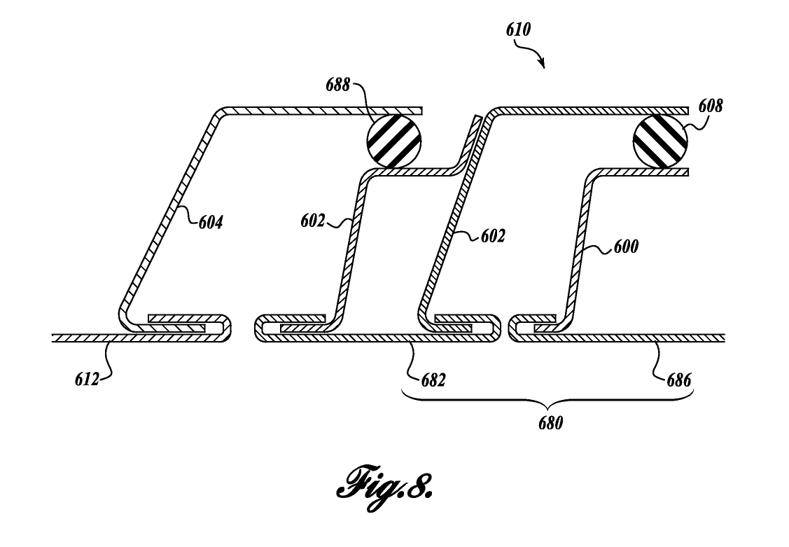

In the embodiments discussed below, the sidewall enclosure assembly can optionally take many forms, depending on, for instance, the functionality or aesthetic appearance desired of the sidewall enclosure assembly. For example, the sidewall enclosure assembly can be embodied as a single door (see sidewall enclosure assembly 214 of FIG. 2), a fixed panel (see sidewall enclosure assembly 314 of FIG. 3), two independent doors (see sidewall enclosure assembly 414 of FIG. 4), a fixed panel and a door (see sidewall enclosure assembly 514 of FIG. 5), or a double door (see sidewall enclosure assemblies 614 and 714 of FIGS. 6 and 7, respectively). Each embodiment of a sidewall enclosure assembly will now be described in more detail.

Referring to FIG. 2, a first embodiment of a sidewall enclosure assembly 214 for use with an access opening 210 in the sidewall 212 of a cab/sleeper unit 218 is depicted. The sidewall enclosure assembly 214 is defined by a door 220 that is substantially the same size and shape as the access opening 210. The door 220 may be any suitable configuration. In the illustrated embodiment, the door 220 includes a window 222; however, it should be appreciated that such a window 222 is an optional feature.

The door 220 is provided with at least one hinge 224 secured along an elongated edge of the door 220. The hinges 224 are attachable to the sidewall 212 of the cab/sleeper unit 218 near the access opening 210. As such, the door 220 may be reciprocated between open and closed positions to selectively cover the access opening 210. For example, when the door 220 is opened, a person situated on the exterior of the cab/sleeper unit 218 may have access to, for instance, a bed and/or a toolbox inside the cab/sleeper unit 218. This maybe useful when, for example, a first person would like to access the interior of the sleeper (to get into and out of the sleeper or to access the toolbox) without disturbing someone in the cab portion of the cab/sleeper unit 218. Moreover, in the closed position, the door 220 acts as a substantial barrier from any noise, weather conditions, etc. In that regard, the sidewall enclosure assembly 214 may further include a seal 226, having substantially the same size and shape as the access opening 210, disposed between the door 220 and the sidewall 212 of the cab/sleeper unit 218 so as to provide a weather tight interface between the door 220 and the sidewall 212.

Turning now to FIG. 3, a second embodiment of a sidewall enclosure assembly 314 for use with an access opening 310 in the sidewall 312 of a cab/sleeper unit 318 is depicted. A wall panel 330 that is substantially the same size and shape as the access opening 310 defines the sidewall enclosure assembly 314. The wall panel 330 closes out the access opening 310 in a more permanent manner than the door 320 of FIG. 2. By providing a relatively permanent covering of the opening 310, the wall panel 330 prevents further access to the cab/sleeper unit 218 via the opening 310.

In the embodiment illustrated in FIG. 3, the wall panel 330 is affixed to the cab/sleeper unit 318 by a plurality of brackets 332 that attach to both the wall panel 330 and the sleeper sidewall 312 at the margins of the access opening 310. The use of brackets 332 to affix the wall panel 330 in the opening 310 is only one example of a type of fixture useful with the enclosure assembly 314. It will be appreciated that any fixtures capable of affixing the wall panel 330 to the sleeper sidewall 312 are useful in the embodiments provided herein, including clamps, bolts, screws, and the like.

Similar to the embodiment described in FIG. 2, a seal 326 can be disposed intermediate the wall panel 330 and the sidewall 312 so as to provide a weather tight wall panel 330.

Turning now to FIGS. 4 and 5, third and fourth embodiments of sidewall enclosure assemblies 414 and 515 are depicted, wherein the sidewall enclosure assemblies 414 and 515 are comprised of at least two modular enclosures. The modular enclosures can be doors, fixed panels, or combinations thereof.

Referring first to FIG. 4, the third embodiment of a sidewall enclosure assembly 414 for use with an access opening 410 in the sidewall 412 of a cab/sleeper unit 418 is depicted. The sidewall enclosure assembly 414 is substantially the same size and shape as the opening 410. The sidewall enclosure assembly 414 is defined by an upper door 442, a lower door 444, and a carrier insert 452 disposed between the upper and lower doors 442 and 444.

Each of the doors 442 and 444 are attached to the sleeper sidewall 412 near the access opening 410 with one or more hinges 446 that allow for reciprocation between open and closed positions. An upper seal 448 substantially the same size and shape as the upper door 442 is intermediate the upper door 442 and the sleeper sidewall 412 to provide a weather tight seal. Similarly, a lower seal 450 substantially the same size and shape as the lower door 444 is intermediate the lower door 444 and the sleeper sidewall 412 to provide a weather tight seal.

The carrier insert 452 laterally spans the width of the access opening 410 and divides the access opening 410 into upper and lower closeout openings that provide access to different areas of the interior of the sleeper, such as the bed (through the upper door 442) and the toolbox (through the lower door 444). The upper and lower openings may be selectively covered by the upper and lower doors 442 and 444. In that regard, the carrier insert 452 is vertically positioned intermediate the upper seal 448 and the lower seal 450. The carrier insert 452 also functions to cover the portion of the access opening 410 in the space between the upper door 442 and the lower door 444 when the doors are closed.

The carrier insert 452 makes it possible to install one or more modular closeouts or enclosures into a single access opening 410. In this regard, it should be appreciated that the carrier insert 452 may be configured to divide the opening 410 into any desired number of smaller closeout openings that are sized and shaped to receive a desired enclosure, such as a door, panel, etc.

The carrier insert 452 is affixed to the sleeper sidewall 412 using techniques known to those of skill in the art (e.g., bolts, screws, etc.). The carrier insert 452 may be formed from a metal, a plastic, a composite, or combinations thereof.

The lower and upper doors 444 and 442 in combination are substantially the same size and shape as the access opening 410. The lower door 444 is sized and shaped to provide access to the floor of the cab/sleeper unit 418 proximal to the opening 410. Such access is useful, for example, when a toolbox or other item is stored within a compartment in the floor of the cab/sleeper unit 418. Accordingly, such an access door is sometimes referred to as a “toolbox door.” The lower door 444 is a dedicated toolbox door that allows an operator to reach through a smaller closeout opening (defined by the carrier insert 452) to access a tool or other item inside the cab/sleeper unit 418. Such a dedicated, smaller closeout opening helps increase efficiency in obtaining tools and does not require a full-sized door to be opened. This is helpful, for example, when an operator wishes to access the toolbox without disturbing someone sleeping on the bed in the sleeper unit.

The upper door 442 is sized and shaped to provide access to another portion of the cab/sleeper unit 418, such as the bed, and may be configured, for example, to allow a person access to, or egress from, the bed of the cab/sleeper unit 418.

Turning now to FIG. 5, the fourth embodiment of the sidewall enclosure assembly 514 for use with an access opening 510 in the sidewall 512 of a cab/sleeper unit 518 is depicted. The sidewall enclosure assembly 514 is defined by an affixed upper panel 562, a lower door 564, and a carrier insert 574 disposed between the upper panel 562 and the lower door 564. The carrier insert 574 divides the access opening 510 into upper and lower closeout openings that are coverable by the upper affixed panel 562 and the lower doors 564, respectively. The carrier insert 574 is substantially identical to the carrier insert 474 described above; and therefore, the carrier insert 574 will not be described in detail.

The sidewall enclosure assembly 514 provides an operator with access to the interior of the cab/sleeper unit 518 through the lower “toolbox” door 564, while maintaining closure of the upper opening that would provide access to, for instance, a bed in the cab/sleeper unit 518. The upper portion of the opening 510 (defined by carrier insert 574) is enclosed by the panel 562 that is not readily openable. Accordingly, the embodiment of FIG. 5 is configured to provide toolbox access through a lower portion of the opening 510 without disturbing a person in the bed of the cab/sleeper unit 518.

The lower door 564 is provided with at least one hinge 566 secured along an edge of the door 564. The hinges 566 are attachable to the sidewall 512 of the cab/sleeper unit 518 near the access opening 510. As such, the lower door 564 may be reciprocated between open and closed positions to selectively provide access to the toolbox area of the cab/sleeper unit 518.

The upper panel 562 is affixed to the sleeper sidewall 512 surrounding the opening 510 using one or more brackets 568, similar to the wall panel 330 of FIG. 3. The upper panel 562 and lower door 564 are made weather tight against the sleeper sidewall 512 by way of an upper seal 570 and a lower seal 572 disposed between the panel 562 and the sidewall 512 and the door 564 and the sidewall 512, respectively. The carrier insert 574 also covers or closes out the gap formed between the upper panel 562 and the lower door 564.

While the embodiment illustrated in FIG. 5 includes a fixed upper panel 562 and a lower door 564, it will be appreciated that additional embodiments contemplate the opposite arrangement: a fixed panel on the lower portion of the access opening 510, and a door on the upper portion of the access opening 510. However, a lower door 564 is particularly useful as a toolbox door, as described above with regard to FIG. 4.

Turning now to FIGS. 6 and 7, fifth and sixth embodiments of sidewall enclosure assemblies 614 and 714 for an access opening are depicted as double door assemblies. Double door assemblies are particularly useful in providing multiple options for a vehicle operator to access the interior of the cab/sleeper unit. For example, a double door assembly may be used to provide entry to the sleeper area of a vehicle for an operator, access to the toolbox area of a vehicle interior, or both, as will be described in more detail below.

Turning now to FIG. 6, the fifth embodiment of the sidewall enclosure assembly 614 for use with an access opening 610 in the sidewall 612 of a cab/sleeper unit 618 is depicted. In the illustrated embodiment, the sidewall enclosure assembly 614 is defined by a first double door assembly 680 that provides access to a sleeper area and/or a toolbox area of a cab/sleeper unit 618.

The double door assembly 680 includes an entry door 682 that is substantially the same size and shape as the access opening 610, which allows a vehicle operator to, for instance, enter into the interior of the cab/sleeper unit 618, or have access to the bed within the cab/sleeper unit 618, when the entry door 682 is opened. The entry door 682 is mounted to the sidewall 612 by one or more hinges (not illustrated) and is moveable between open and closed positions.

An access door 686 is embedded within the entry door 682 to provide access to a limited, predetermined portion of the interior of the cab/sleeper unit 618. The access door 686 is inset from the lateral and lower edges of the entry door 682 or is otherwise located within the entry door 680 to provide access to the predetermined interior portion of the cab/sleeper unit 618, such as a toolbox area located beneath a sleeper bed. The access door 686 forms a portion of the entry door 680 and therefore moves with the entry door 680 when the entry door 680 is moved between open and closed positions. However, the access door 686 is also configured to open independently from the entry door 682.

In the illustrated embodiment of FIG. 6, the access door 686 is a toolbox door positioned and configured to provide access to a toolbox area of the cab/sleeper unit 618 proximal to the access opening 610 (similar to the access door 444 described with reference to FIG. 4). It will be appreciated, however, that the access door 686 can be sized, positioned, and configured as needed to provide access to other interior compartments or areas within the sleeper interior. Additionally, access door 686 can be two or more doors, instead of the single door illustrated.

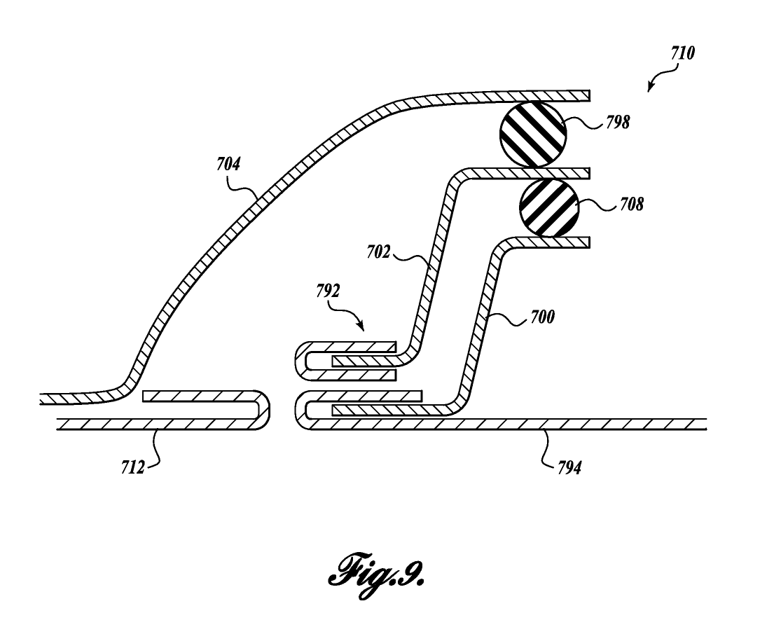

Referring to FIG. 8, a description of an exemplary construction of the double door assembly 680 will be hereinafter provided. In the depicted embodiment of the double door assembly 680, the entry door 682 and access door 686 both open away from the sleeper sidewall 612. The access door 686 is hingedly connected to, and can open independently from, the entry door 682. It will be appreciated that the entry door 682 and the access door 686 need not open in the same direction.

In the exemplary configuration illustrated in FIG. 8, a seal 608 is disposed intermediate an access door frame 600 and an entry door frame 602 so as to provide a weather tight connection between the doors. Accordingly, when the access door 686 is closed, the access door frame 600 sealingly engages with the entry door frame 602 by compressing the seal 608. When the access door 686 is in a closed position, as illustrated in FIG. 8, a latch or other fixation mechanism (not illustrated) acts to keep the access door 686 in place. In order to open the access door 686 independently from the entry door 682, the latch is released (e.g., manually or electronically), at which point the access door 686 can swing freely.

A seal 688 is also disposed intermediate a sidewall door frame 604 and the entry door frame 602 so as to provide a weather tight connection between the entry door 682 and the sidewall 612. Accordingly, when the entry door 682 is closed, the sidewall door frame 604 sealingly engages with the entry door frame 602 by compressing the seal 688. The entry door 682 may be latched (not illustrated) when in the closed position, as illustrated in FIG. 8.

As can be appreciated from the foregoing, the access door 686 can be opened independently of the entry door 682 (e.g., for toolbox access when the entry door 682 is closed). If the entry door 682 is opened, however, the access door 686 opens in unison with the entry door 682 (e.g., the entire double door assembly 680 opens as a single door unit).

A second embodiment of a sidewall enclosure assembly 714 depicted as a double door assembly 790 is illustrated in FIG. 7. In this embodiment, the double door assembly 790 includes an entry door 792 and an access door 794. The access door 794 is embedded within the entry door 792 in a manner similar to that described with reference to FIG. 6. However, in the embodiment illustrated in FIG. 7, the lateral width of both the entry door 792 and the access door 794 are the same; whereas, in the double door assembly 680 illustrated in FIG. 6, the access door 686 is surrounded marginally by the entry door 682. Accordingly, the double door assembly 790 of FIG. 7 provides a variation on the double door assembly design that allows for maximum width of the access door 794.

Referring to FIG. 9, an exemplary construction of the double door assembly 790 will now be described. The access door 794 is secured within the entry door 792 such that when the access door 794 is closed, the exterior surface of the access door 794 is substantially flush with the exterior surface of the sleeper sidewall 712. However, in contrast to the embodiment depicted in FIGS. 6 and 8, the entry door 792 does not surround the access door 794 and therefore the entry door 792 does not have an exterior surface exposed to the exterior of the cab/sleeper unit 718 at the bottom of the double door assembly 790. Instead, the entry door 792 includes an entry door frame 702 that is nested behind an access door frame 700. The access door frame 700 sealingly engages the entry door frame 702 with a seal 708. Furthermore, the entry door frame 702 sealingly engages a sidewall door frame 704 with a seal 798.

In the exemplary embodiment of the double door assembly 790 illustrated in FIG. 9, the access door 794 can be opened independently of the entry door 792. If the access door 794 is opened independently of the entry door 792, a portion of the entry doorframe 702 is exposed. The entry door 792 can also be opened, in which case, the access door 794 opens in unison with the entry door 792. In this manner, the entry door 792 and access door 794 open as a single door unit to provide access to the cab/sleeper unit 718 interior such that an operator can enter the cab/sleeper unit 718.

The embodiments described herein with regard to FIGS. 6-9 can be distinguished from earlier-described embodiments, such as those described with reference to FIG. 4, in that the double door assemblies 680 and 790 have an access door and an entry door that are joined together such that if the entry door (e.g., 682 and 792) is opened, the entire double door assembly 680 or 790 (including the access door and the entry door) will open. In comparison, in the embodiment illustrated in FIG. 4, the upper door 442 and lower door 444 open and close independent of one another.

It will be appreciated that the modular nature of the sidewall enclosure assemblies and methods provided herein allow for modification of a sidewall enclosure assembly after it is installed on a cab/sleeper unit during production. For example, if a door 220 is initially installed, as illustrated in FIG. 2, at a later time, the door 220 may be removed and a combination fixed panel 562 and lower door 564, such as illustrated in FIG. 5, could be installed. Such a change may be desirable, for example, if a vehicle is transferred to a new operator who requires different functionality of the sleeper (e.g., only toolbox access is needed).

While illustrative embodiments have been illustrated and described, it will be appreciated that various changes can be made therein without departing from the spirit and scope of the invention.

1. A sidewall enclosure assembly for selectively providing access to an interior portion of a vehicle having a sidewall with an access opening formed in the sidewall, the sidewall enclosure assembly comprising:
(a) an insert selectively attachable to a portion of the sidewall such that it divides the access opening into at least first and second closeout openings; and
(b) at least one modular closeout sealingly engageable with the sidewall and the insert to enclose one of the first and second closeout openings.

2. The assembly of claim 1, wherein the first closeout opening is vertically aligned above the second closeout opening.

3. The assembly of claim 1, wherein the at least one modular closeout is selected from the group consisting of a door closeout and a fixed-panel closeout.

4. The assembly of claim 1, further comprising a seal disposed between the at least one modular closeout and a portion of the sidewall surrounding the access opening.

5. The assembly of claim 1, wherein the insert laterally spans the access opening.

6. The assembly of claim 1, further comprising a first modular closeout sealingly engageable with the sidewall and the insert to enclose the first closeout opening and a second modular closeout sealingly engageable with the sidewall and the insert to enclose the second closeout opening.

7. The assembly of claim 1, wherein the first closeout and the second closeout are independently selected from the group consisting of a door closeout and a fixed-panel closeout.

8. A sidewall enclosure assembly for selectively providing access to an interior portion of a vehicle having a sidewall and an access opening defined in the sidewall, the access opening sized and configured to allow vehicle interior trim components to be passed through the access opening during vehicle assembly, the sidewall enclosure assembly comprising:
a double door assembly sealingly engageable with the sidewall to cover the access opening, wherein the double door assembly comprises:
(i) an entry door moveable between open and closed positions, the entry door sized and configured to provide access to a first interior portion of the vehicle when the entry door is opened; and
(ii) a lower access door defined in a bottom portion of the entry door such that the lower access door moves with the entry door when the entry door is moved between open and closed positions, the lower access door being hingedly connected to the entry door and configured to open independent of the entry door and sized and shaped to provide access to a second interior portion of the vehicle.

9. The assembly of claim 8, wherein the lower access door provides access to a toolbox area within the interior of the vehicle proximal to the double door.

10. The assembly of claim 8, wherein the entry door and the lower access door each have a width substantially equal to the width of the double door assembly.

11. The assembly of claim 8, wherein the lower access door is embedded in the entry door.

12. A method for assembling an interior of a vehicle having a cab portion and a sleeper portion, the method comprising:
(a) defining an access opening in a sidewall of the sleeper portion of the vehicle that provides access to an interior of the sleeper portion;
(b) passing at least one interior trim component through the access opening and into the interior of the sleeper portion;
(c) installing the at least one interior trim component in the interior of the sleeper portion; and
(d) covering the access opening with a sidewall enclosure assembly, comprising:
(i) an insert selectively attachable to a portion of the sidewall such that it divides the access opening into at least first and second closeout openings; and
(ii) at least one modular closeout sealingly engageable with the sidewall and the insert to enclose one of the first and second closeout openings.

13. A method of assembling an interior of a truck sleeper, the method comprising:
(a) defining an access opening in a sidewall of the truck sleeper that provides access to the interior portion of the truck sleeper;
(b) passing a sleeper component for installation in the truck sleeper through the access opening and into the interior portion of the truck sleeper;
(c) installing the at least one interior sleeper component in the interior portion of the sleeper; and
(d) covering the access opening with a sidewall enclosure assembly, the sidewall enclosure assembly comprising a double door assembly sealingly engageable with the sidewall to cover the access opening, wherein the double door assembly comprises:
(i) an entry door moveable between open and closed positions, the entry door sized and configured to provide access to a first interior portion of the vehicle when the entry door is opened; and
(ii) an access door defined in a portion of the entry door such that the access door is configured to move with the entry door when the entry door is moved between an open and a closed positions, the access door configured to open independent of the entry door and sized and shaped to provide access to a second interior portion of a vehicle.

14. The method of claim 13, wherein the sleeper component is a furniture component.

15. The method of claim 13, wherein the sleeper component is a bed.

16. The assembly of claim 8, wherein the interior portion of the vehicle is a sleeper section of a truck.
